(19) United States
(12) Patent Application Publication
(10) Pub. No.: US 2011/0149116 A1
(43) Pub. Date: Jun. 23, 2011

(54) IMAGING DEVICE AND METHOD FOR SHARING MEMORY AMONG CHIPS

(76) Inventor: Wang-Hyun KIM, Namyangju-si (KR)

(21) Appl. No.: 12/883,746

(22) Filed: Sep. 16, 2010

(30) Foreign Application Priority Data
Dec. 17, 2009 (KR) 10-2009-0125937

(51) Int. Cl. H04N 5/907

(52) U.S. Cl. 348/231.99

(57) ABSTRACT

An imaging device and a memory sharing method are provided. The imaging device includes: an image sensor; an image signal processor chip that includes a frame memory and that receives and processes a video signal from the image sensor; and a control processor chip that receives video information from the image signal processor chip via a first serial interface and that accesses the frame memory via a second serial interface used for the image signal processor chip to receive the video image signal from the image sensor. Accordingly, it is possible to efficiently utilize resources in a movable communication terminal having a camera function.

### CROSS REFERENCE

This application is based on and claims priority under 35USC 119 from Korean Patent Application No. 10-2009-0125937, filed on Dec. 17, 2009.

### BACKGROUND

1. Field of the Invention

The present invention relates to an imaging device, and more particularly, to an imaging device and a memory sharing method between chips.

2. Description of the Related Art

Recently, various imaging devices such as a mobile communication terminal having a camera function and a digital camera have been developed. In the mobile communication terminal having a camera function, various chips provided to carry out the camera function are not always activated but the activations thereof are determined depending on their functions.

FIG. 1 is a sectional view of a mobile communication terminal having a camera function according to the related art.

Referring to FIG. 1, the mobile communication terminal having a camera function includes an image sensor 10, an image signal processor chip 20, and a multimedia processor chip 30. The multimedia processor chip 30 may be a baseband chip.

The multimedia processor chip 30 controls the image signal processor chip 20 via an I2C (Inter-Integrated Circuit)/SPI (Serial Peripheral Interface). The image signal processor chip 20 controls the image sensor 10 in accordance with an input command.

A video signal output from the image sensor 10 is transmitted via a parallel interface (I/F) or an MIPI (Mobile Industry Processor Interface) which is a high-speed serial interface. The image signal processor chip 20 also transmits video information, which is obtained by processing the video signal, via the parallel interface or the MIPI to the multimedia processor chip 30 or the baseband chip.

The image signal processor chip 20 includes a memory (for example, DRAM) for post-processing, which is stacked therein. Examples of the post-processing include still DIS, motion DIS, CPS, face detection, smile/blink detection, digital zoom, thumbnail, transmission of JPEG to correspond to one Vsync, and image rotation. A DRAM is provided as a frame memory for the processes.

With the recent increase in the number of pixels of the image sensor 10 to 8M pixels, 12M pixels, 13M pixels, and 15M pixels, the MIPI which is a high-speed serial interface has attracted attention for transmit a large amount of image for a given time.

FIG. 2 is a diagram illustrating a CSI-2 and a CCI interface constituting the MIPI (Mobile Industry Processor Interface).

As shown in the drawing the CSI-2 is a differential signal resulting from a data line and a clock line and the CCI interface is like the I2C protocol.

Since the transmission rate of the MIPI varies depending on transmitters, and receivers, and connection states, an accurate transmission rate is not defined. The MIPI standard document suggests a solution for a transmission rate of 80 to 1000 Mbps per lane.

However, in the mobile communication terminal having a camera function according to the related art, when the image signal processor chip is not activated, there is not suggested an effective method of allowing another chip to utilize the memory in the image signal processor chip.

The above-mentioned related art is technical information which is thought out to make the invention or is learned by the inventor in the course of making the invention, but cannot be thus said to be technical information known to the public before filing the invention.

### SUMMARY

An advantage of some aspects of the invention is that it provides an imaging device and a memory sharing method, which can efficiently utilize resources in a mobile communication terminal having a camera function.

Another advantage of some aspects of the invention is that it provides an imaging device and a memory sharing method, which can allow another chip (for example, one or more of a baseband chip and a multimedia processor chip) to utilize a memory shared to perform additional functions, by allowing another chip to efficiently share a memory (for example, DRAM) in an image signal processor chip of a mobile communication terminal having a camera function when the image signal processor chip is not used.

Other advantages of the invention will be easily understood from the following description.

According to an aspect of the invention, there is provided an imaging device including: an image sensor; an image signal processor chip that includes a frame memory and that receives and processes a video signal from the image sensor; and a control processor chip that receives video information from the image signal processor chip via a first serial interface and that accesses the frame memory via a second serial interface used for the image signal processor chip to receive the video image signal from the image sensor.

Each of the first and second serial interfaces may be an MIPI (Mobile Industry Processor Interface).

The image processor chip may further include: a transmitter that communicates via the first serial interface; a receiver that receives data via the second serial interface; a serial interface unit that communicates with the control processor chip via a third serial interface; a memory interface controller that is connected to the transmitter, the receiver, and the frame memory and that controls the frame memory; and a register in which setting information on one or more of the first to third serial interfaces is recorded.

The control processor chip may transmit a command for accessing the frame memory via the third serial interface and the settings of the register and the memory interface controller may be updated to correspond to the command.

The third serial interface may include one or more an I2C (Inter-Integrated Circuit) and an SPI (Serial Peripheral Interface).

The control processor chip may include one or more of a multimedia processor chip and a baseband chip.

The frame memory may be stacked in the image signal processor chip.

The frame memory may be a DRAM.

According to another aspect of the invention, there is provided a memory sharing method among chips which is carried out in an imaging device including an image sensor, an image sensor signal processor chip, and a control processor chip, including the steps of: causing the control processor chip to transmit a predetermined command to the image signal processor chip via a first serial interface for the purpose of accessing a frame memory in the image signal processor chip; and causing the image signal processor chip to update its setting details in response to the command so as to allow the control processor chip to access the frame memory.

The first interface may include one or more of an I2C (Inter-Integrated Circuit) and an SPI (Serial Peripheral Interface).

The control processor chip may receive video information from the image signal processor chip via a second serial interface and may access the frame memory via a third serial interface used for the image signal processor chip to receive the video signal from the image sensor.

The control processor chip may be supplied with data stored in the frame memory via the second serial interface.

Each of the second and third serial interfaces may be an MIPI (Mobile Industry Processor Interface).

The control processor chip may include one or more of a multimedia processor chip and a baseband chip.

The frame memory may be stacked in the image signal processor chip.

The frame memory may be a DRAM.

Other aspects, features, and advantages will become apparent from the accompanying drawings, the appended claims, and the detailed description.

According to the above-mentioned configurations, it is possible to efficiently utilize resources in a mobile communication terminal having a camera function.

It is also possible to allow another chip (for example, one or more of a baseband chip and a multimedia processor chip) to utilize a memory shared to perform additional functions, by allowing another chip to efficiently share a memory (for example, DRAM) in an image signal processor chip of a mobile communication terminal having a camera function when the image signal processor chip is not used.

### BRIEF DESCRIPTION OF THE DRAWINGS

FIG. 1 is a diagram illustrating the configuration of a mobile communication terminal having a camera function according to the related art.

FIG. 2 is a diagram illustrating a CSI-2 and a CCI interface constituting a MIPI (Mobile Industry Processor Interface).

FIG. 3 is a diagram illustrating the SPI protocol.

FIGS. 4A and 4B are diagrams illustrating the I2C protocol.

FIG. 5 is a diagram illustrating the configuration of a mobile communication terminal having a camera function according to an embodiment of the invention.

FIG. 6 is a block diagram schematically illustrating the configuration of an image signal processor chip according to an embodiment of the invention.

### DESCRIPTION OF EXEMPLARY EMBODIMENTS

The invention can be variously modified in various forms and specific embodiments will be described and shown in the drawings. However, the embodiments are not intended to limit the invention, but it should be understood that the invention includes all the modifications, equivalents, and replacements belonging to the spirit and the technical scope of the invention. When it is determined that detailed description of known techniques associated with the invention makes the gist of the invention obscure, the detailed description will be omitted.

Terms such as “first” and “second” can be used to describe various elements, but the elements are not limited to the terms. The terms are used only to distinguish one element from another element.

The terms used in the following description are used to merely describe specific embodiments, but are not intended to limit the invention. An expression of the singular number includes an expression of the plural number, so long as it is clearly read differently. The terms such as “include” and “have” are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

Terms, “unit”, “-er(-or)”, “module”, and the like, described in the specification mean a unit for performing at least one function or operation and can be embodied by hardware, by software, or by a combination of hardware and software.

So long as they are not defined differently, all the terms used therein, which include technical or scientific terms, have the same meanings as generally understood by those skilled in the art. The terms defined in dictionaries used in general should be analyzed to have the same meaning as in the contexts of the related art, but the terms should not be analyzed ideal or excessively formal as long as they are not clearly defined.

The exemplary embodiments of the invention will be described below in detail with reference to the accompanying drawings.

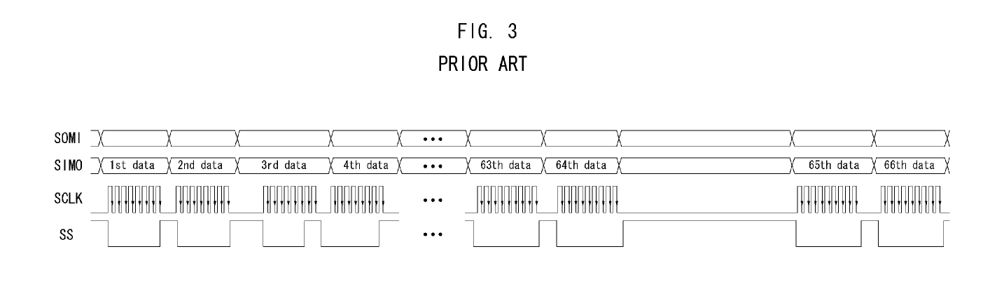

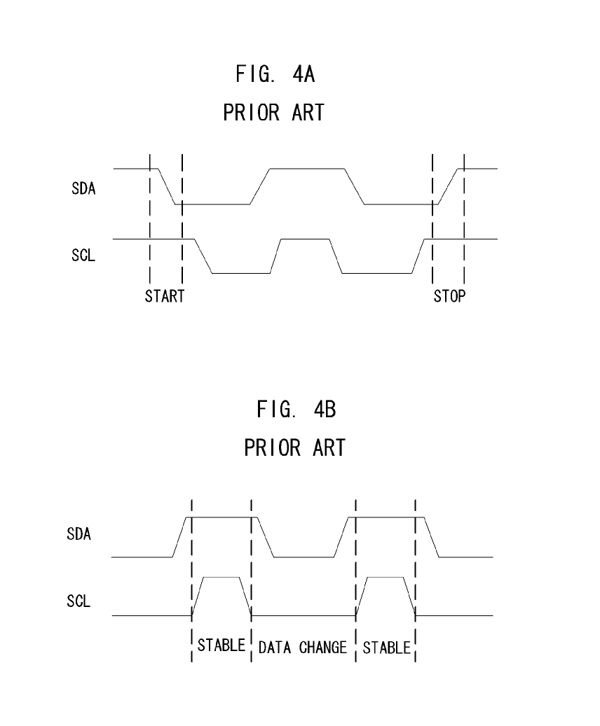

FIG. 3 is a diagram illustrating the SPI protocol. FIGS. 4A and 4B are diagrams illustrating the I2C protocol. Signals output from pins in an SPI communication using a kind of serial interface and an I2C communication will be described in brief with reference to FIGS. 4A and 4B.

As shown in FIG. 3, in the SPI, four pins for transmitting and receiving SS, SCLK, SIMO, and SOMI signals are used to communicate.

The SS (Slave Select) signal is a slave selecting signal. Accordingly, a master can select a slave using the SS signal.

The SCLK (SPI Clock) signal is a clock signal output from a master to a slave. The master and the slave load data on the SCLK signal.

The SOMI (Single-Output Multiple-Input) signal is a signal transmitted from a master to a slave and is used to transmit data from the master to the slave.

The SIMO (Single-Input Multiple-Output) signal is a signal transmitted from a slave from a master, and is used to transmit data from the master to the slave. In the SPI, two pins outputting the SS signal and the SCLK form a control line and two pins outputting the SIMO signal and the SOMI signal forms a data line.

As shown in FIGS. 4A and 4B, in the I2C communication, the master and the slave communicate with each other using two pins of SDA (serial data) and SCL (Serial Clock input).

Here, as shown in FIG. 4A, start and end of a protocol exist in parts where only the SDA signal varies. As shown in FIG. 4B, data between the start and the end is valid only when the SDA signal includes the SCL signal.

When this condition is satisfied, one pin outputting the SDA signal forms a data line and one pine outputting the SCL signal forms a control line.

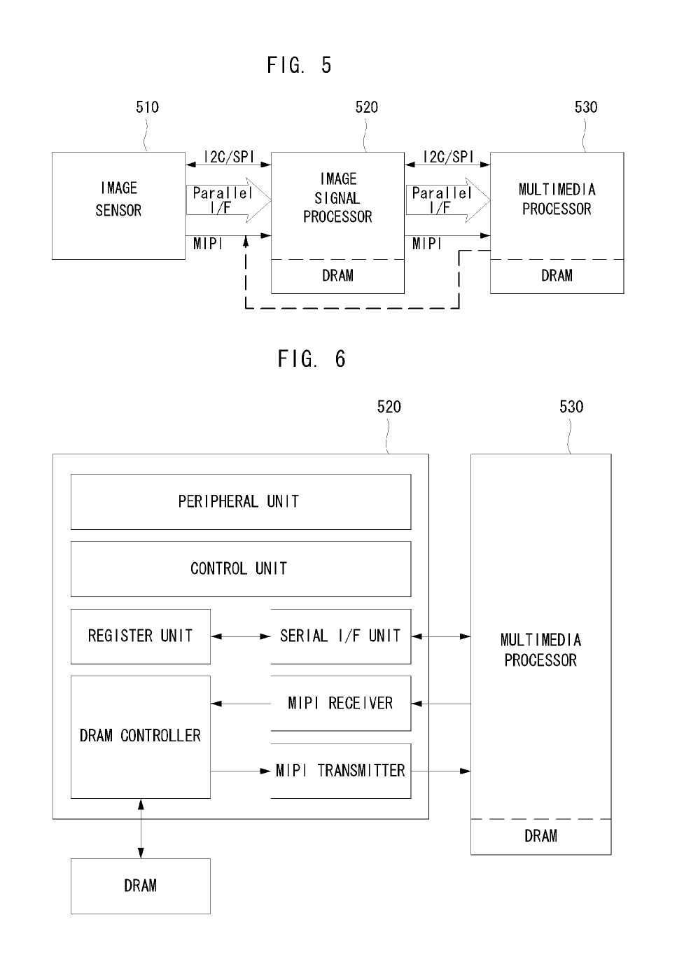

FIG. 5 is a diagram illustrating the configuration of a mobile communication terminal having a camera function according to an embodiment of the invention. FIG. 6 is a block diagram schematically illustrating the configuration of an image signal processor chip according to an embodiment of the invention.

Referring to FIGS. 5 and 6, the mobile communication terminal having a camera function includes an image sensor 510, an image signal processor chip 520, and a multimedia processor chip 530. The multimedia processor chip 530 may be a baseband chip.

The multimedia processor chip 530 (or the baseband chip, which is the same in the following description) controls the image signal processor chip 520 via an I2C (Inter-Integrated Circuit)/SPI (Serial Peripheral Interface). The image signal processor chip 520 controls the image sensor 510 in accordance with an input command.

A video signal output from the image sensor 510 is transmitted via a parallel interface or an MIPI (Mobile Industry Processor Interface which is a high-speed serial interface. The image signal processor chip 520 transmits video information, which is obtained by processing the video signal, to the multimedia processor chip 530 or the baseband chip via the parallel interface or the MIPI.

The image signal processor chip 520 includes a memory (for example, DRAM) for post-processing, which is stacked therein. Examples of the post-processing include still DIS, motion DIS, CPS, face detection, smile/blink detection, digital zoom, thumbnail, transmission of JPEG to correspond to one Vsync, and image rotation. For example, a DRAM is provided as a frame memory for the processes.

When the camera function of the mobile communication terminal is not used, the image signal processor chip 520 along the frame memory (for example, DRAM) stacked therein is maintained in a power-down or power-off state

In this case, the multimedia processor chip 530 including an MIPI transmitter transmits a command for utilizing the frame memory to the image signal processor chip 520 via a serial interface such as the I2C or the SPI so as to access the frame memory stacked in the image signal processor chip 520.

Here, the command may relate to the setting details of a DRAM controller (for example, MIC (Memory Interface Controller, see FIG. 6), logics such as the DMA, and logics controlling the MIPI. The DRAM controller is a memory interface controller, which is a module controlling the frame memory (for example, DRAM). The DMA (Direct Memory Access) is a block that receives data from an element (for example, MIPI receiver), which intends to use the frame memory, and transmits the received data to the DRAM controller.

The image signal processor chip 520 having received the command sets up the DRAM controller and the registers of the DMA blocks to prepare for the sending the data received via the MIPI receiver to the frame memory.

The multimedia processor chip 530 checks whether the frame memory stacked in the image signal processor chip 520 is set up in accordance with the command previously transmitted via the serial interface and can be utilized. By reading values recorded in a predetermined register in the image signal processor chip 520 via the serial interface, it can be checked whether such setting is completed.

When the frame memory can be utilized, the multimedia processor chip 530 stores data in the frame memory stacked in the image signal processor chip 520 reads the data stored in the frame memory via the MIPI which is a high-speed serial interface. For this purpose, the multimedia processor chip 530 transmits data to be stored to the DRAM controller via the MIPI to store the data in the frame memory and receives data to be read in response to a request to the DRAM controller.

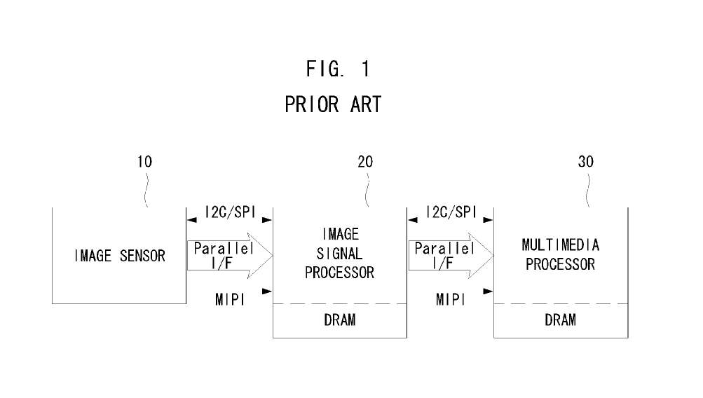

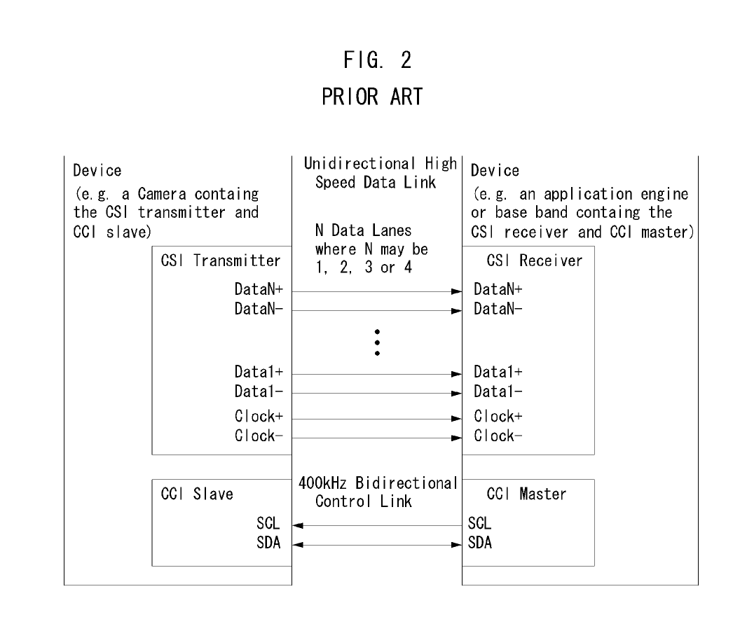

As described above, when the camera function is not used, the multimedia processor chip 530 communicates with the MIPI receiver and the DRAM controller of the image signal processor chip 520 to access the frame memory stacked in the image signal processor chip 520. This communication path is indicated by a dotted line in FIG. 5 and is different from the communication path described with reference to FIG. 1.

Elements of the image processor chip 520 shown in FIG. 6 will be described in brief below. FIG. 6 shows an exemplary configuration of the image processor chip 520, and the image processor chip 520 is not limited to this configuration.

In FIG. 6, a peripheral unit includes peripheral devices such as a GPIO, a UART, and a PWM and a control unit may be a central processing unit such as 8051 and ARM. A register unit may be a register for setting up the peripheral unit in the image signal processor chip and the DRAM controller is a memory interface controller and performs a function of control the frame memory (for example, DRAM). A serial I/F unit performs a communication function employing the I2C or SPI. An MIPI receiver and An MIPI transmitter perform a function of communicating via the MIPI.

The above-mentioned memory sharing method among chips may be carried out in a time-series automated procedure by a software program built in a digital processor. Codes and code segments of the program will be easily obtained by programmers skilled in the art. The program can be stored in a computer-readable recording medium and can be read and executed by a computer to embody the above-mentioned method. Examples of the recording medium include a magnetic recording medium, an optical recording medium, and a carrier wave medium.

While the invention has been described with reference to the exemplary embodiments, it will be understood by those skilled in the art that the invention can be modified and changed in various forms without departing from the spirit and scope of the invention described in the appended claims.

What is claimed is:

1. An imaging device comprising:
an image sensor;
an image signal processor chip that includes a frame memory and that receives and processes a video signal from the image sensor; and
a control processor chip that receives video information from the image signal processor chip via a first serial interface and that accesses the frame memory via a second serial interface used for the image signal processor chip to receive the video signal from the image sensor.

2. The imaging device according to claim 1, wherein each of the first and second serial interfaces is an MIPI (Mobile Industry Processor Interface).

3. The imaging device according to claim 1, wherein the image processor chip includes:
a transmitter that communicates via the first serial interface;
a receiver that receives data via the second serial interface;
a serial interface unit that communicates with the control processor chip via a third serial interface;
a memory interface controller that is connected to the transmitter, the receiver, and the frame memory and that controls the frame memory; and
a register in which setting information on one or more of the first to third serial interfaces is recorded.

4. The imaging device according to claim 3, wherein the control processor chip transmits a command for accessing the frame memory via the third serial interface and the setting details of the register and the memory interface controller are updated to correspond to the command.

5. The imaging device according to claim 3, wherein the third serial interface includes one or more of an I2C (Inter-Integrated Circuit) and an SPI (Serial Peripheral Interface).

6. The imaging device according to claim 1, wherein the control processor chip includes one or more of a multimedia processor chip and a baseband chip.

7. The imaging device according to claim 1, wherein the frame memory is stacked in the image signal processor chip.

8. The imaging device according to claim 1, wherein the frame memory is a DRAM.

9. A memory sharing method among chips which is carried out in an imaging device including an image sensor, an image sensor signal processor chip, and a control processor chip, comprising
causing the control processor chip to transmit a predetermined command to the image signal processor chip via a first serial interface for the purpose of accessing a frame memory in the image signal processor chip; and
causing the image signal processor chip to update its setting details in response to the command so as to allow the control processor chip to access the frame memory.

10. The memory sharing method according to claim 9, wherein the first interface includes one or more of an I2C (Inter-Integrated Circuit) and an SPI (Serial Peripheral Interface).

11. The memory sharing method according to claim 9, wherein the control processor chip receives video information from the image signal processor chip via a second serial interface and accesses the frame memory via a third serial interface used for the image signal processor chip to receive the video signal from the image sensor.

12. The memory sharing method according to claim 11, wherein the control processor chip is supplied with data stored in the frame memory via the second serial interface.

13. The memory sharing method according to claim 11, wherein each of the second and third serial interfaces is an MIPI (Mobile Industry Processor Interface).

14. The memory sharing method according to claim 9, wherein the control processor chip includes one or more of a multimedia processor chip and a baseband chip.

15. The memory sharing method according to claim 9, wherein the frame memory is stacked in the image signal processor chip.

16. The memory sharing method according to claim 9, wherein the frame memory is a DRAM.
